(19) United States
(12) Patent Application Publication
(10) Pub. No.: US 2015/0051953 A1
(43) Pub. Date: Feb. 19, 2015

(54) METHOD AND SYSTEM FOR GEOLOCATION MAPPING OF INDOOR LOCATIONS USING PAYMENT DATA

(71) Applicant: MasterCard International Incorporated, Purchase, NY (US)

(72) Inventor: Justin X. HOWE, Oakdale, NY (US)

(73) Assignee: MasterCard International Incorporated, Purchase, NY (US)

(21) Appl. No.: 13/969,839

(22) Filed: Aug. 19, 2013

(51) Int. Cl. G06Q 30/02

(52) U.S. Cl. CPC G06Q 30/0205
USPC 705/7.34

(57) ABSTRACT

A method for mapping merchant boundaries includes: storing, in a transaction database, a plurality of transaction data entries, wherein each transaction data entry includes data related to a payment transaction including at least a merchant identifier, a consumer identifier, and a transaction time and/or date; identifying, in the transaction database, a subset of transaction data entries, wherein each transaction data entry in the subset of transaction data entries includes a common merchant identifier; receiving, for each transaction data entry in the identified subset of transaction data entries, a geographic location of a mobile communication device associated with the respective included consumer identifier temporally proximal to the respective included transaction time and/or date; and generating, by a processing device, a boundary map for a merchant associated with the common merchant identifier based on the geographic locations received for each transaction data entry in the identified subset of transaction data entries.

### FIELD

The present disclosure relates to the mapping of merchant locations, specifically the use of payment data and geolocation data of mobile devices to generate a map of merchant locations.

### BACKGROUND

There are a variety of benefits to having an accurate map of a merchant's physical location. Among some of the benefits are valuable statistics that could be gathered from such maps, as well as the great utility that such maps can offer consumers. In particular, maps of indoor locations, such as shopping malls that may include a large number of merchants, may be especially valuable to consumers. In addition, the ability to map accurate physical locations of a merchant may be valuable to map providers, who may then provide the accurate maps to the consumers for use.

Current methods for mapping indoor merchant locations typically use physical equipment that must be placed near the merchant location. These pieces of equipment may use sound waves or audio/video spectrum data acquired through various tools to create a map. However, these methods suffer from a number of problems. For example, they are unable to identify what merchant is established at each detected location without additional human intervention, and they require a physical presence at each location in order to map. Such methods would be unable to accurately and efficiently map indoor locations of merchants without a significant amount of physical equipment and human assistance, and would also be unable to quickly adjust for changes in the occupation of a specific location. Another method that is currently used for mapping indoor locations relates to the aggregating of digital blueprints provided by building owners. However, this method also suffers from a number of problems, as it requires the manual providing of data by a large number of independent operators, and may only be performed in areas where the building owner has provided data. Additionally, any update to such a map would require additional cooperation by the building owners, which can result in a delayed and inefficient updating of merchant location maps.

Thus, there is a need for a technical system that can accurately and efficiently map the physical locations of merchants that can also be updated in real-time.

### SUMMARY

The present disclosure provides a description of systems and methods for mapping merchant boundaries.

A method for mapping merchant boundaries includes: storing, in a transaction database, a plurality of transaction data entries, wherein each transaction data entry includes data related to a payment transaction including at least a merchant identifier, a consumer identifier, and a transaction time and/or date; identifying, in the transaction database, a subset of transaction data entries, wherein each transaction data entry in the subset of transaction data entries includes a common merchant identifier; receiving, for each transaction data entry in the identified subset of transaction data entries, a geographic location of a mobile communication device associated with the respective included consumer identifier temporally proximal to the respective included transaction time and/or date; and generating, by a processing device, a boundary map for a merchant associated with the common merchant identifier based on the geographic locations received for each transaction data entry in the identified subset of transaction data entries.

A system for mapping merchant boundaries includes a transaction database, a processing device, and a receiving device. The transaction database is configured to store a plurality of transaction data entries, wherein each transaction data entry includes data related to a payment transaction including at least a merchant identifier, a consumer identifier, and a transaction time and/or date. The processing device is configured to identify, in the transaction database, a subset of transaction data entries, wherein each transaction data entry in the subset of transaction data entries includes a common merchant identifier. The receiving device is configured to receive, for each transaction data entry in the identified subset of transaction data entries, a geographic location of a mobile communication device associated with the respective included consumer identifier temporally proximal to the respective included transaction time and/or date. The processing device is further configured to generate a boundary map for a merchant associated with the common merchant identifier based on the geographic locations received for each transaction data entry in the identified subset of transaction data entries.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for mapping merchant boundaries in accordance with exemplary embodiments.

FIG. 2 is a block diagram illustrating the processing server of FIG. 1 for the mapping of merchant boundaries in accordance with exemplary embodiments.

FIG. 3 is a flow diagram illustrating a method for receiving payment and geolocation data use thereof to map merchant boundaries in accordance with exemplary embodiments.

FIGS. 4A-4D are diagrams illustrating the identification of geolocations associated with payment data and subsequent generation of merchant boundary maps in accordance with exemplary embodiments.

FIG. 5 is a flow chart illustrating an exemplary method mapping merchant boundaries in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

### System for Mapping Merchant Boundaries

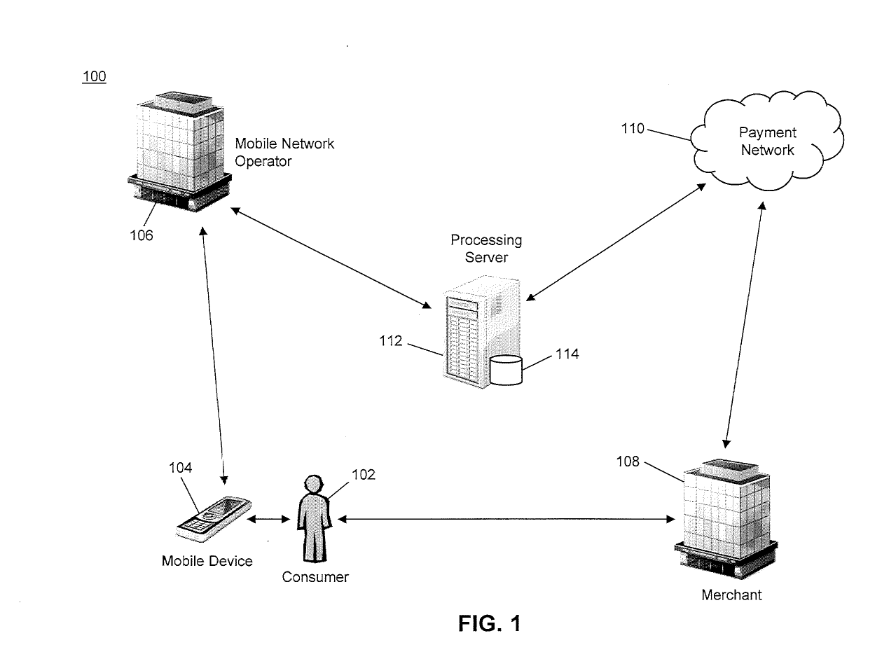

FIG. 1 illustrates a system 100 for mapping boundaries of a merchant location using geolocation and payment data.

A consumer 102 may be associated with a particular mobile device 104. The mobile device 104 may be mobile communication device, such as a cell phone, smart phone, tablet computer, laptop computer, etc. whose geographic location (e.g., geolocation) may be identified. Types of mobile devices 104 suitable for use in performing the functions as disclosed herein will be apparent to persons having skill in the relevant art. In some embodiments, the mobile device 104 may be in communication with a mobile network operator 106, such as a cellular network operator 106.

The consumer 102 may visit a physical location of a merchant 108 for engaging in a payment transaction, such as a transaction for the purchase of goods or services. The consumer 102 may be in possession of their mobile device 104 when at the premises of the merchant 108 and while engaging in the payment transaction. During the consumer's 102 shopping experience at the merchant 108, the geographic location of the mobile device 104 may be identified.

Identification of the geolocation of the mobile device 104 may be done using methods and systems that will be apparent to persons having skill in the relevant art. In some embodiments, the mobile network operator 106 may use cellular network triangulation. In other embodiments, the mobile device 104 may identify its geographic location using the global positioning system, an application program stored on and executed by the mobile device 104, or identification via Bluetooth, radio frequency identification (RFID), Wi-Fi, and audio location determination. For example, the mobile device 104 may connect with a Wi-Fi network at the location of the merchant 108, which may determine its geographic location.

As part of the conducting of the payment transaction involving the consumer 102 and the merchant 108, the merchant 108 (e.g., or an acquirer, such as an acquiring bank, on behalf of the merchant 108) may generate an authorization request for the payment transaction, which may then be submitted to a payment network 110 for processing. The payment network 110 may process the payment transaction using systems and methods apparent to persons having skill in the relevant art, and then transmit transaction data for the payment transaction to a processing server 112. The transaction data may include a merchant identifier (e.g., associated with the merchant 108), a consumer identifier (e.g., associated with the consumer 102), and a time and/or date when the transaction occurred (e.g., initiated, authorized, cleared, etc.).

The processing server 112 may receive the transaction data, which it may store in a transaction database 114, discussed in more detail below. The processing server 112 may then identify the transaction data stored in the transaction database 114 for all transactions involving the merchant 108. The processing server 112 may identify the consumers 102 involved in each of the transactions involving the merchant 108, and request from the mobile network operator 106 the geographic location data for the mobile devices 104 associated with each identified consumer 102 temporally proximal to the time and/or date of the respective transaction. Once the processing server 112 has the geographic location data, the processing server 112 may generate a boundary map for the merchant 108 using the geographic location data, as discussed in more detail below.

The system 100 may be beneficial over traditional systems and methods for mapping merchant boundaries, as the processing server 112 may be able to map the boundary of the merchant 108 without the use of any physical equipment near the physical location of the merchant 108. In addition, the processing server 112 may be able to update the boundary map of the merchant 108 in real-time as new transactions and subsequent location data are received. Furthermore, the processing server 112 may be able to automatically update a boundary map to indicate a change in merchant. For example, if the processing server 112 begins to receive transactions indicating a different merchant for the same location as a previous merchant at a specific point in time, the processing server 112 may be able to determine that a specific location has a new merchant without the need to physically visit the location or be updated via human interaction.

Processing Device

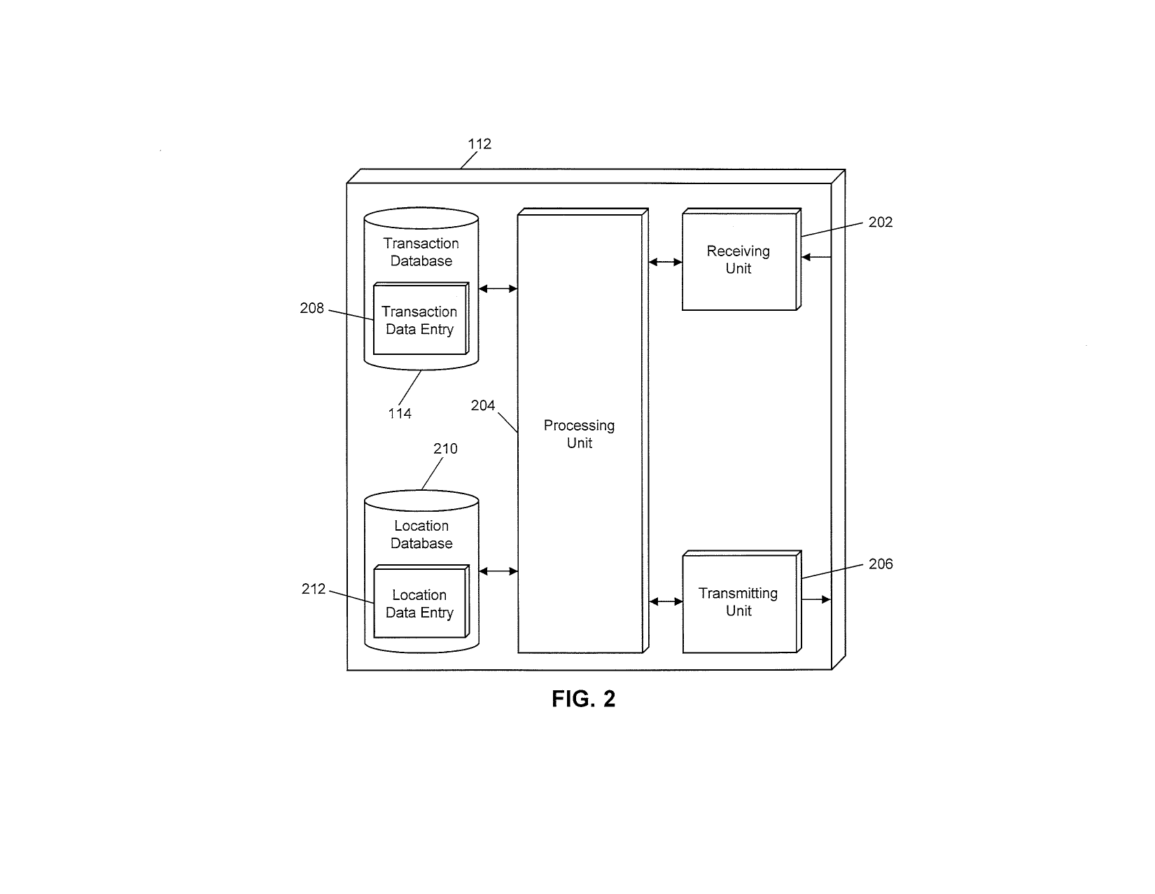

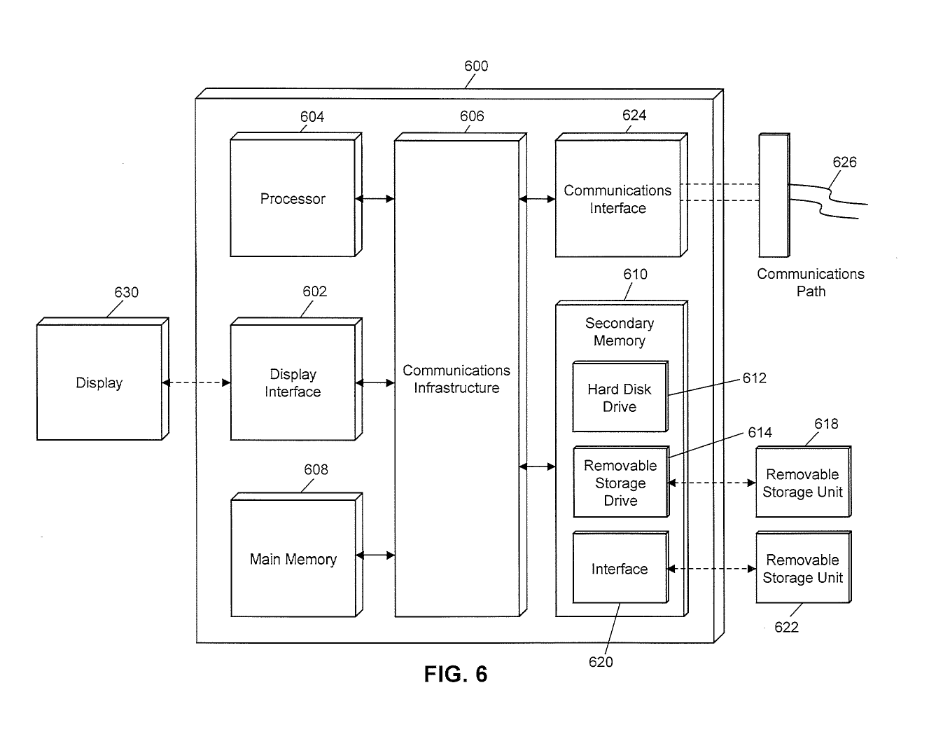

FIG. 2 illustrates an embodiment of the processing server 112 of the system 100. It will be apparent to persons having skill in the relevant art that the embodiment of the processing server 112 illustrated in FIG. 2 is provided as illustration only and may not be exhaustive to all possible configurations of the processing server 112 suitable for performing the functions as discussed herein. For example, the computer system 600 illustrated in FIG. 6 and discussed in more detail below may be a suitable configuration of the processing server 112.

The processing server 112 may include a receiving unit 202. The receiving unit 202 may be configured to receive transaction data from the payment network 110 and geolocation data from the mobile network operator 106 (e.g., and/or the mobile device 104). The receiving unit 202 may be configured to communicate with one or more networks via one or more protocols as will be apparent to persons having skill in the relevant art. The processing server 112 may also include a processing unit 204, which may be configured to store the received transaction data in the transaction database 114 as a plurality of transaction data entries 208.

Each transaction data entry 208 may be related to a payment transaction and include a consumer identifier, a merchant identifier, and a transaction time and/or date. The consumer identifier may be a unique value associated with a consumer (e.g., the consumer 102) involved in the related payment transaction that may be used to identify the associated consumer. For example, the consumer identifier may be a payment account number, an identification number, a phone number, an e-mail address, a username, a hardware address (e.g., a media access control address, internet protocol address, etc.). The merchant identifier may be a unique value associated with a merchant (e.g., the merchant 108) involved in the related payment transaction that may be used to identify the associated merchant. For example, the merchant identifier may be a merchant identification number (MID) or other value as will be apparent to persons having skill in the relevant art.

The transaction time and/or date may be a time at which the related payment transaction was conducted. The time may be the time at which the transaction data for the transaction was entered into a point-of-sale device, an authorization request was generated, the authorization request was submitted to the payment network 110, approval for the payment transaction was received at the point-of-sale, or any other suitable time as will be apparent to persons having skill in the relevant art. In some embodiments, each transaction data entry 208 may also include additional transaction data, such as a transaction amount, merchant name, product data, etc.

The processing server 112 may also include a location database 210. The location database 210 may include a plurality of location data entries 212, which may store geographic location data for mobile devices 104 received by the receiving unit 202 (e.g., from the mobile network operator 106). Each location data entry 212 may include a consumer identifier associated with the consumer 102 to whom the geographic location corresponds (e.g., based on the corresponding mobile device 104 being associated with the consumer 102), the geographic location, and a time and/or date at which the geographic location was identified.

The processing unit 204 may be configured to identify, in the transaction database 114, a group or subset of transaction data entries 208 where the included merchant identifier is a common merchant identifier, such as a merchant identifier associated with the merchant 108. The processing unit 204 may then identify location data entries 212 in the location database 210 where the consumer identifier matches and where the time and/or date of the geographic location is temporally proximal to the transaction time and/or date in the corresponding transaction data entry 208. The resulting geographic locations may thus be representative of the location of the consumer 102 at the time of or just before engaging in the payment transaction with the merchant 108. In some embodiments, the processing unit 204 may also identify previous geographic locations in order to develop a path of the consumer 102 prior to the transaction.

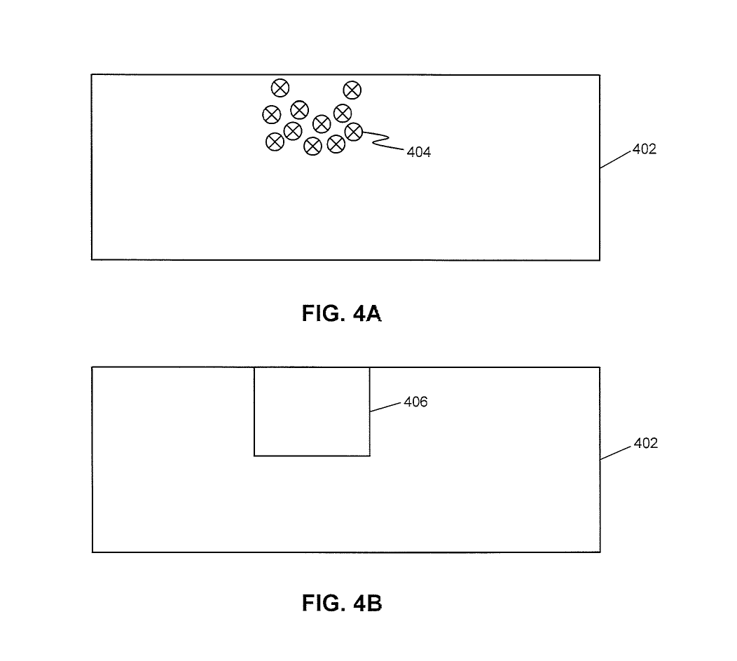

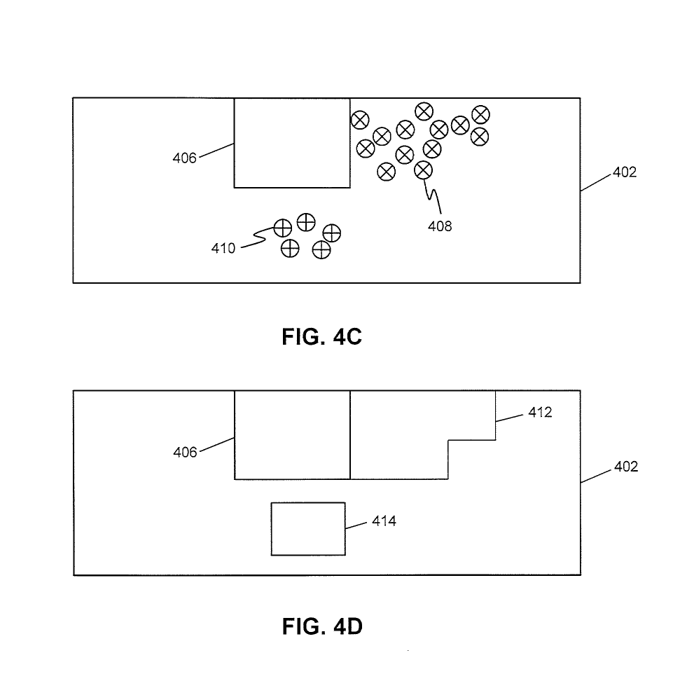

The processing unit 204 may then generate a boundary map based on the identified geographic locations, as illustrated in FIGS. 4A-4D and discussed in more detail below. In some embodiments, the receiving unit 202 may receive a request for a map including a specific merchant identifier. The processing unit 204 may generate a boundary map for the specified merchant, which may then be transmitted in response to the request by a transmitting unit 206. The transmitting unit 206 may be configured to communicate with one or more networks via one or more protocols as will be apparent to persons having skill in the relevant art.

### Method for Identifying Payment and Geolocation Data and Mapping Merchant Boundaries

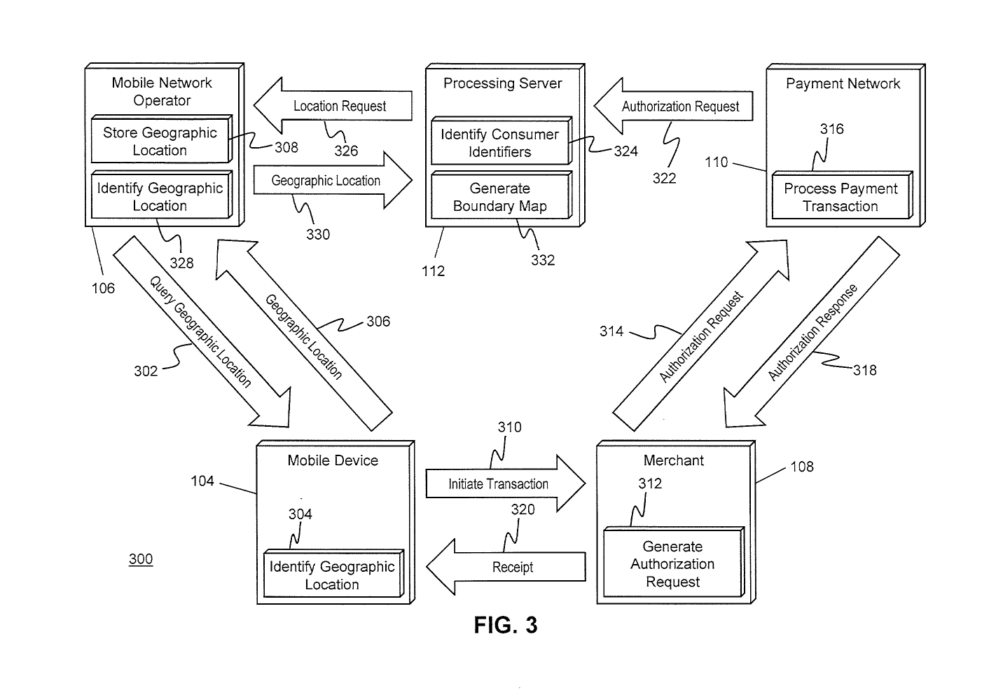

FIG. 3 is a flow diagram illustrative of a method for identifying payment data and geolocation data and the use thereof to generate a boundary map.

In step 302, the mobile network operator 106 may query the mobile device 104 for its geographic location. In step 304, the mobile device 104 may identify its geographic location using methods that will be apparent to persons having skill in the relevant art. In one embodiment, the mobile network operator 106 may identify the geographic location (e.g., via cellular network triangulation). In step 306, the mobile device 104 may provide the identified geographic location (e.g., or data necessary to identify the geographic location) to the mobile network operator 106. The mobile network operator 106 may then store the received geographic location in a database, in step 308.

In step 310, a transaction may be initiated with the merchant 108 between the mobile device 104 (e.g., the consumer 102 in possession of the mobile device 104) and the merchant 108. The merchant 108 may enter the transaction data into a point-of-sale device and then, in step 312, the merchant 108 may generate an authorization request for the payment transaction. The authorization request may include a merchant identifier associated with the merchant 108, a consumer identifier associated with the consumer 102, and a time and/or date of the transaction. The authorization request may be submitted to the payment network 110 in step 314.

In step 316, the payment network 110 may process the payment transaction and then may transmit an approval of the transaction via an authorization response, in step 318. The merchant 108 may receive the authorization response indicating the approval of the payment transaction and, in step 320, may finalize the transaction, such as by furnishing a receipt to the consumer 102 and/or the mobile device 104.

In step 322, the payment network 110 may transmit a copy of the authorization request, or the relevant data included therein, to the processing server 112. The processing server 112 may receive the transaction data and store it in the transaction database 114. Then, in step 324, the processing server 112 may identify consumer identifiers in a subset of transaction data entries including the merchant identifier corresponding to the merchant 108 as a common merchant identifier. In step 326, the processing server 112 may transmit (e.g., by the transmitting unit 206) a request for location data for each of the identified consumer identifiers and the corresponding transaction time and/or dates.

In step 328, the mobile network operator 106 may identify the geographic locations for the consumers at the requested time and/or dates as identified in the location request. Then, in step 330, the mobile network operator 106 may transmit the identified geolocation data to the processing server 112. In step 332, the processing server 112 may use the geolocation data to generate a boundary map for the merchant 108.

### Boundary Map Generation

FIGS. 4A-4D illustrate the generation of a boundary map for merchants based on geolocation data from mobile devices associated with consumers involved in payment transactions with the corresponding merchants.

FIG. 4A illustrates an indoor area 402 that may include a plurality of merchants, such as an indoor shopping mall or flea market. The processing server 112 may identify a geographic location 404 corresponding to each transaction data entry identified in a subset of transaction data entries related to payment transactions involving a specific merchant, such as the merchant 108. As illustrated in FIG. 4A, the geographic locations 404 may be clustered in a specific area.

The processing server 112 may generate a boundary map 406 for the merchant 108 based on the geographic locations 404, as illustrated in FIG. 4B. The boundary map 406 may be an approximation of the boundaries of the merchant 108 based on the geographic locations 404. Although the boundary map 406 is illustrated as being a quadrilateral, it will be apparent to persons having skill in the relevant art that the boundary map 406 may be any type of shape.

The processing server 112 may also be configured to map multiple merchant boundaries on a single map. For example, as illustrated in FIG. 4C, the processing server 112 may obtain geographic locations 408 and 410 for a second and third merchant, respectively. The processing server 112 may then identify a boundary map 412 for the second merchant and a boundary map 414 for the third merchant, based on the geolocation data.

In some embodiments, the boundary map for two merchants may overlap based on the corresponding geolocation data. In such an embodiment, the processing server 112 may trim the edges of the boundary maps based on the geolocation data to approximate the boundaries. In some instances, the processing server 112 may also extend boundaries for multiple merchants until intersection to provide an accurate boundary map. For example, the processing server 112 may use the geographic locations 404 to identify a centroid for the merchant 108, and then may expand the boundaries of the centroid until intersection with the boundaries of another merchant.

### Exemplary Method for Mapping Merchant Boundaries

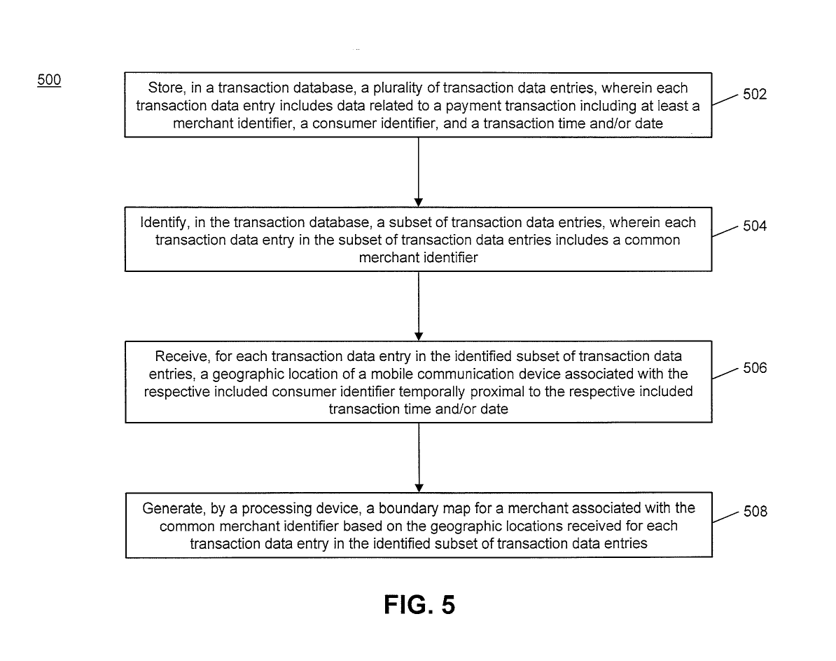

FIG. 5 illustrates a method 500 for mapping merchant boundaries of a merchant 108 based on captured geolocation and payment data.

In step 502, a plurality of transaction data entries (e.g., transaction data entries 208) may be stored in a transaction database (e.g., the transaction database 114), wherein each transaction data entry 208 includes data related to a payment transaction including at least a merchant identifier, a consumer identifier, and a transaction time and/or date.

In step 504, a subset of transaction data entries may be identified, in the transaction database 114, wherein each transaction data entry 208 in the subset of transaction data entries includes a common merchant identifier.

In step 506, a receiving device (e.g., the receiving unit 202) may receive, for each transaction data entry 208 in the identified subset of transaction data entries, a geographic location (e.g., geographic location 404) of a mobile communication device (e.g., the mobile device 104) associated with the respective included consumer identifier temporally proximal to the respective included transaction time and/or date. In some embodiments, the received geographic location 404 may be identified using at least one of: a global positioning system, an application program executed by the respective mobile communication device 104, cellular network triangulation of the respective mobile communication device 104, and Bluetooth, radio frequency identification, Wi-Fi, and audio location determination. In a further embodiment, the application program may be part of an electronic wallet program. In one embodiment, the geographic location may be represented using latitude, longitude, and altitude.

In step 508, a processing device (e.g., the processing unit 204) may generate a boundary map (e.g., the boundary map 406) for a merchant (e.g., the merchant 108) associated with the common merchant identifier based on the geographic locations 404 received for each transaction data entry 208 in the identified subset of transaction data entries. In some embodiments, the generated boundary map 406 may be a three-dimensional boundary map.

In one embodiment, the method 500 may further include: identifying, in the transaction database 114, a second subset of transaction data entries, wherein each transaction data entry in the second subset of transaction data entries includes a second common merchant identifier; receiving, for each transaction data entry 208 in the identified second subset of transaction data entries, a geographic location (e.g., a geographic location 408) of a mobile communication device associated with the respective included consumer identifier temporally proximal to the respective included transaction time and/or date; and generating, by the processing device 204, a second boundary map (e.g., the boundary map 412) for a merchant associated with the second common merchant identifier based on the geographic locations 408 received for each transaction data entry 208 in the identified second subset of transaction data entries and the generated boundary map 406 for the merchant associated with the common merchant identifier.

In a further embodiment, the method 500 may even further include generating, by the processing device 204, a combined boundary map based on the generated boundary map 406 for the merchant 108 associated with the common merchant identifier, and the generated boundary map 412 for the merchant associated with the second common merchant identifier. In an even further embodiment, generating the combined boundary map may include trimming overlapping boundaries for the merchant 108 associated with the common merchant identifier and the merchant associated with the second common merchant identifier.

In another embodiment, the method 500 may further include: receiving, by the receiving device 202, a new transaction data entry including the common merchant identifier, a specific consumer identifier, and a specific transaction time and/or date; receiving, by the receiving device 202, a new geographic location 404 of a mobile communication device (e.g., the mobile device 104) associated with the specific consumer identifier temporally proximal to the specific transaction time and/or date; and updating, by the processing device 204, the generated boundary map 406 for the merchant 108 associated with the common merchant identifier based on the received new geographic location 404.

In yet another embodiment, receiving a geographic location 404 of the mobile communication device 104 may further include receiving a plurality of geographic locations 404 of the mobile communication device 104 during a predetermined period of time prior to the respective included transaction time and/or date, and generating, by the processing device 204, a movement path for the mobile communication device 104 for use in the generating step. In a further embodiment, the predetermined period of time may be based on a merchant category associated with the merchant 108 associated with the common merchant identifier. For example, the predetermined period of time may be greater for a large retail store than for a small fast food vendor.

In another embodiment, the method 500 may also include identifying, by the processing device 204, a geo-fence for the merchant 108 associated with the common merchant identifier based on the generated boundary map 406. In yet another embodiment, the method 500 may further include associating, by the processing device 204, the generated boundary map 406 for the merchant 108 with a name of the merchant 108. In a further embodiment, the name of the merchant 108 may be included in at least one of the transaction data entries 208 included in the subset of transaction data entries.

### Computer System Architecture

FIG. 6 illustrates a computer system 600 in which embodiments of the present disclosure, or portions thereof, may be implemented as computer-readable code. For example, the processing server 112 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for mapping merchant boundaries. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for mapping merchant boundaries, comprising:
storing, in a transaction database, a plurality of transaction data entries, wherein each transaction data entry includes data related to a payment transaction including at least a merchant identifier, a consumer identifier, and a transaction time and/or date;
identifying, in the transaction database, a subset of transaction data entries, wherein each transaction data entry in the subset of transaction data entries includes a common merchant identifier;
receiving, for each transaction data entry in the identified subset of transaction data entries, a geographic location of a mobile communication device associated with the respective included consumer identifier temporally proximal to the respective included transaction time and/or date; and
generating, by a processing device, a boundary map for a merchant associated with the common merchant identifier based on the geographic locations received for each transaction data entry in the identified subset of transaction data entries.

2. The method of claim 1, further comprising:
identifying, in the transaction database, a second subset of transaction data entries, wherein each transaction data entry in the second subset of transaction data entries includes a second common merchant identifier;
receiving, for each transaction data entry in the identified second subset of transaction data entries, a geographic location of a mobile communication device associated with the respective included consumer identifier temporally proximal to the respective included transaction time and/or date; and
generating, by the processing device, a second boundary map for a merchant associated with the second common merchant identifier based on the geographic locations received for each transaction data entry in the identified second subset of transaction data entries and the generated boundary map for the merchant associated with the common merchant identifier.

3. The method of claim 2, further comprising:
generating, by the processing device, a combined boundary map based on the generated boundary map for the merchant associated with the common merchant identifier and the generated second boundary map for the merchant associated with the second common merchant identifier.

4. The method of claim 3, wherein generating the combined boundary map includes trimming overlapping boundaries for the merchant associated with the common merchant identifier and the merchant associated with the second common merchant identifier.

5. The method of claim 1, further comprising:
receiving, by the receiving device, a new transaction data entry including the common merchant identifier, a specific consumer identifier, and a specific transaction time and/or date;
receiving, by the receiving device, a new geographic location of a mobile communication device associated with the specific consumer identifier temporally proximal to the specific transaction time and/or date; and
updating, by the processing device, the generated boundary map for the merchant associated with the common merchant identifier based on the received new geographic location.

6. The method of claim 1, wherein receiving a geographic location of a mobile communication device associated with the respective included consumer identifier for each transaction data entry in the identified subset of transaction data entries further includes
receiving a plurality of geographic locations of the mobile communication device during a predetermined period of time prior to the respective included transaction time and/or date, and
generating, by the processing device, a movement path for the mobile communication device for use in the generating step.

7. The method of claim 6, wherein the predetermined period of time is based on a merchant category associated with the merchant associated with the common merchant identifier.

8. The method of claim 1, further comprising:
identifying, by the processing device, a geo-fence for the merchant associated with the common merchant identifier based on the generated boundary map.

9. The method of claim 1, wherein the received geographic location of each mobile communication device is identified using at least one of: a global positioning system, an application program executed by the respective mobile communication device, cellular network triangulation of the respective mobile communication device, and Bluetooth, radio frequency identification, Wi-Fi, and audio location determination.

10. The method of claim 9, wherein the application program is part of an electronic wallet program.

11. The method of claim 1, wherein the geographic location is represented using latitude, longitude, and altitude.

12. The method of claim 1, wherein the generated boundary map for the merchant associated with the common merchant identifier is a three-dimensional boundary map.

13. The method of claim 1, further comprising:
associating, by the processing device, the generated boundary map for the merchant with a name of the merchant.

14. The method of claim 13, wherein the name of the merchant is included in at least one of the transaction data entries included in the subset of transaction data entries.

15. A system for mapping merchant boundaries, comprising:
a transaction database configured to store a plurality of transaction data entries, wherein each transaction data entry includes data related to a payment transaction including at least a merchant identifier, a consumer identifier, and a transaction time and/or date;
a processing device configured to identify, in the transaction database, a subset of transaction data entries, wherein each transaction data entry in the subset of transaction data entries includes a common merchant identifier; and
a receiving device configured to receive, for each transaction data entry in the identified subset of transaction data entries, a geographic location of a mobile communication device associated with the respective included consumer identifier temporally proximal to the respective included transaction time and/or date, wherein
the processing device is further configured to generate a boundary map for a merchant associated with the common merchant identifier based on the geographic locations received for each transaction data entry in the identified subset of transaction data entries.

16. The system of claim 15, wherein
the processing device is further configured to identify, in the transaction database, a second subset of transaction data entries, wherein each transaction data entry in the second subset of transaction data entries includes a second common merchant identifier,
the receiving device is further configured to receive, for each transaction data entry in the identified second subset of transaction data entries, a geographic location of a mobile communication device associated with the respective included consumer identifier temporally proximal to the respective included transaction time and/or date, and
the processing device is further configured to generate a second boundary map for a merchant associated with the second common merchant identifier based on the geographic locations received for each transaction data entry in the identified second subset of transaction data entries and the generated boundary map for the merchant associated with the common merchant identifier.

17. The system of claim 16, wherein the processing device is further configured to generate a combined boundary map based on the generated boundary map for the merchant associated with the common merchant identifier and the generated second boundary map for the merchant associated with the second common merchant identifier.

18. The system of claim 17, wherein generating the combined boundary map includes trimming overlapping boundaries for the merchant associated with the common merchant identifier and the merchant associated with the second common merchant identifier.

19. The system of claim 15, wherein
the receiving device is further configured to
receive a new transaction data entry including the common merchant identifier, a specific consumer identifier, and a specific transaction time and/or date, and
receive a new geographic location of a mobile communication device associated with the specific consumer identifier temporally proximal to the specific transaction time and/or date, and
the processing device is further configured to update the generated boundary map for the merchant associated with the common merchant identifier based on the received new geographic location.

20. The system of claim 15, wherein receiving a geographic location of a mobile communication device associated with the respective included consumer identifier for each transaction data entry in the identified subset of transaction data entries further includes
receiving a plurality of geographic locations of the mobile communication device during a predetermined period of time prior to the respective included transaction time and/or date, and
generating, by the processing device, a movement path for the mobile communication device for use in the generating step.

21. The system of claim 20, wherein the predetermined period of time is based on a merchant category associated with the merchant associated with the common merchant identifier.

22. The system of claim 15, wherein the processing device is further configured to identify a geo-fence for the merchant associated with the common merchant identifier based on the generated boundary map.

23. The system of claim 15, wherein the received geographic location of each mobile communication device is identified using at least one of: a global positioning system, an application program executed by the respective mobile communication device, cellular network triangulation of the respective mobile communication device, and Bluetooth, radio frequency identification, Wi-Fi, and audio location determination.

24. The system of claim 23, wherein the application program is an electronic wallet program.

25. The system of claim 15, wherein the geographic location is represented using latitude, longitude, and altitude.

26. The system of claim 15, wherein the generated boundary map for the merchant associated with the common merchant identifier is a three-dimensional boundary map.

27. The system of claim 15, wherein the processing device is further configured to associate the generated boundary map for the merchant with a name of the merchant.

28. The system of claim 27, wherein the name of the merchant is included in at least one of the transaction data entries included in the subset of transaction data entries.
